(19) United States
(12) Patent Application Publication
(10) Pub. No.: US 2005/0171885 A1
(43) Pub. Date: Aug. 4, 2005

(54) Object oriented demographically predictive insurance agency asset evaluation system and method

(76) Inventors: David T. Christman, Indianapolis, IN (US); James W. Wallace, Fishers, IN (US); Melanie S. Otto, Greenwood, IN (US); Kathy R. Yeary, Tipton, IN (US)

Correspondence Address: BAKER & DANIELS LLP, 300 NORTH MERIDIAN STREET, SUITE 2700, INDIANAPOLIS, IN, 46204, US

(21) Appl. No.: 10/980,751

(22) Filed: Nov. 3, 2004

Related U.S. Application Data
(60) Provisional application No. 60/516,690, filed on Nov. 3, 2003.

(51) Int. Cl. G06F 17/60

(52) U.S. Cl. 705/36; 705/4

(57) ABSTRACT

The present invention involves a computer system and method for evaluating a portfolio of insurance policies system and method which evaluates the portfolio. The computer determines relevant data from a database of experiential data relating to insurance policies. Also, characteristics of a portfolio of insurance policies are analyzed and identified by the computer for correspondence to the relevant data. The computer calculates a valuation for the portfolio based on the experiential data and the analyzed characteristics. The database of experiential data relating to insurance policies has financial data and associated demographic data. The computer also indexes policies of the portfolio based on predetermined risk factors. The experiential data may be updated and the valuation recalculated when new experiential data is obtained.

The present application claims the benefit of U.S. Provisional Patent Application No. 60/516,690 filed Nov. 3, 2003.

### BACKGROUND OF THE INVENTION

1. Field of the Invention.

The invention relates to asset evaluation software. More specifically, the field of the invention is that of asset evaluation software for the insurance agency industry.

2. Description of the Related Art

Insurance agents generate income through the sale and servicing of insurance contracts of insurance and financial institutions. Typically, insurance agents assist customers in selecting an insurance company and policy, then assists the customer in dealing with the insurance company for both policy payments and claims on the policy. For the initial sale of the insurance policy, the insurance agency receives a commission. Subsequently, the insurance agent also receives a fee for acting as a local representative of the insurance company for the customer in maintaining and managing the policy. An insurance agency typically deals with many customers of different profiles and demographics, and possibly several insurance companies, to create a portfolio of insurance policies. New customers or existing customers may purchase additional policies, and customers may fail to renew policies, so the exact contents of an insurance agency's portfolio may change daily.

For a variety of business and personal reasons, insurance agencies desire to capitalize on their portfolio of insurance policies. However, because of the several variables relating to the projection of income from existing policies, valuations of such portfolios are problematic. This results in most such valuations assigning a high level of. risk with the portfolio of policies, and decreases the valuation. Insurance agencies must then accept less than a fair value for their portfolios. Correspondingly, the purchasers of the portfolios must maintain substantial reserves to cover the potential degradation of value that is possible because of the high risk. Thus, each party to the transaction desires to have a more accurate valuation.

What is needed in the art is an asset evaluation system and method that improves the quality and accuracy of insurance agency asset evaluation.

### SUMMARY OF THE INVENTION

The present invention is a demographically predictive system and method which accurately evaluates insurance policies based on policy experience. The inventive process recognizes the variables which have high correlations to policy renewal and lapsing, so that a predictive model is developed for each portfolio to provide a more accurate and less risky valuation of each portfolio.

The present invention identifies lapse trends and relationships among them, to thus determine relevant factors for the policies within a portfolio and which causal variables are the best predictors. For example: the system determines lapse relevance and cause by collecting, organizing, and measuring the differential lapse rates of policy count to premium and/or commission received. This data is compared to aggregated experiential values for a particular demographic, such as a particular insurance company, a particular type of policy, a geographic region (possibly as particular as a zip code region), an age block, or any other demographic factor that proves to have a high correlation to the likely continuation of the policies in the portfolio.

The invention also improves on the maintenance of each portfolio, By utilizing causal findings in the experiential data, the portfolio management may be improved by determining the quality of the receivables of the portfolio and their retention, and also to identify risk factors in claims experience and renewal to catch potential fraud. For example, once a relevant lapse trend is identified and associated with correlated possible cause(s), the system may determine and apply the most effective means for correcting the trend, based on prior outcomes for similar mortality, morbidity, and voluntary lapse factors.

Further, the invention allows more accuracy with smaller portfolios. Most insurance evaluation operates under the “law of large numbers” and thus inordinately assigns risk with smaller portfolios. The present invention applies findings recursively to prioritize and evaluate future asset streams, thereby selectively assessing and procuring risk on discrete asset blocks. For example, the system may iteratively change the evaluated price of an income stream by utilizing performance data from prior assets to assign and apply an expected variance score.

The present invention, in one form, relates to a system for (a) collecting, organizing, and measuring premium and commission payments on insurance policies, the timing of such with respect to mode of payment (e.g., monthly, quarterly, semi-annually, or annually) and proximity to due date, and the reason for non-payment where non-payment exists, (b) identifying payment trends, causal factors, and relationships between factors giving rise to such trends, and (c) correcting negative payment trends to improve the evaluation, reliability, and performance of the premium and commission streams.

The present invention, in another form, is a method for gathering, storing, and manipulating insurance premium and commission payment data, and projecting, managing, and improving the performance of such payment streams.

Further aspects of the present invention involve translating and analyzing historical premium and commission payment information in various forms, and converting to and presenting in a common, intuitive, graphically pleasing and actionable user format.

Another aspect of the invention relates to a machine-readable program storage device for storing encoded instructions for a method of interpreting and communicating insurance premium and commission payment trend information for appropriate action according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of an asset evaluation system for insurance agency portfolios using the present invention.

FIG. 2 is a flow chart diagram of the operation of the present invention.

FIG. 3 is a block diagram of data relationships in the asset evaluation system of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an objects methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of bow each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (“CDPD”) used on the Advance Mobile Phone Service (“AMPS”). The terms “wireless application protocol” or “WAP” mean a universal specification to facilitate the delivery and presentation of web-based data on handheld and mobile devices with small user interfaces.

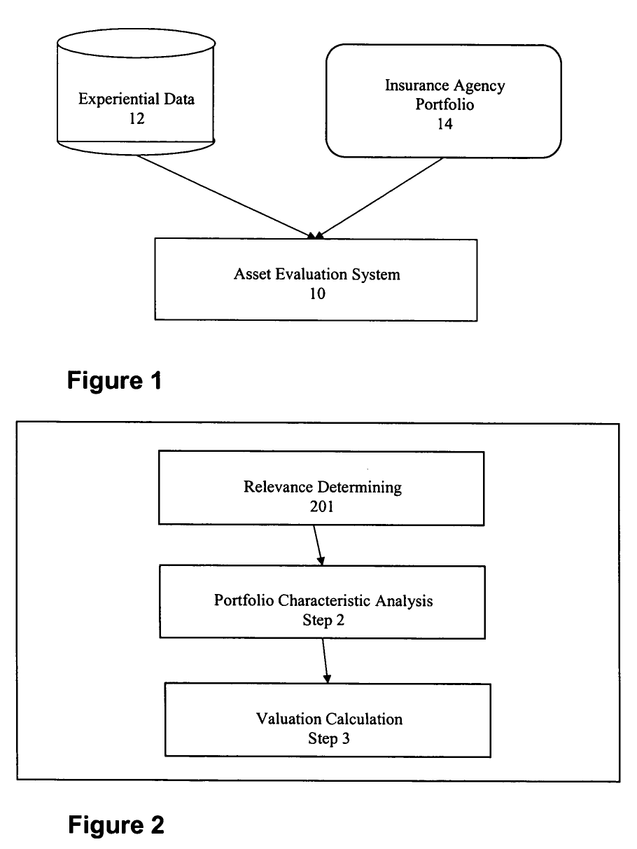

FIG. 1 shows a schematic view of the present invention. In an essential form, Asset Evaluation system 10 uses experiential data 12 to assess the expected value of the various insurance policies in portfolio 14. Asset Evaluation system 10 includes a general computing system with software enabling the operations disclosed herein. In one exemplary embodiment, system 10 includes a neural network which is configured to correlate and classify data in several dimensions to facilitate the present invention. Experiential data 12 includes financial information on the types of insurance policies and insurance companies with many different customers. Data 12 also has associated demographic data which is correlated to such financial information so that the variable demographic data that is most closely related to the premium history, renewal, and lapsing of insurance policies is determined. The process of determining the relevant demographic data is described in greater detail below. Asset Evaluation system 10 accesses the financial and demographic information associated with portfolio 14 to determine a projected value and associated risk factor. The process of determining a projected value and risk factor is described in greater detail below.

FIG. 2 shows the flow chart depicting the method of the present invention. First Relevance determining step 20 involves calculating the correlation between various demographic data points and financially relevant characteristics of historical financial performance of insurance policies from an experiential database. Demographic data that correlates with one or more financial characteristics are identified in this step. Next, relevant demographic data associated with an insurance agency's portfolio is identified in Portfolio Characteristic Analysis step 22. Finally, Valuation Calculation step 22 applies the identified relevant demographic data from the portfolio to the historical financial data from the experiential database.

The means by which causal relevance is determined from historical data is an iterative, recursive process utilizing complex mathematical trend analysis to (a) identify potential payment trends and (b) determine the relative impact of various demographic characteristics to that trend. An example of this process would be the tabulation of a series of premium and commission payments by date, mode, amount, age of policyholder, and insurance carrier. By performing, in the simplest case, a comparison of payment duration for policyholders of equal age, mode, and amount but different carrier, it is possible to draw conclusions about the impact of certain carriers on future payment streams. In situations where comparative experiential data is sparse or negligible, a neural network analysis may be substituted, drawing inferences from observed data only. The outcome of both processes is the identification and prioritization of key factors that contribute to the exhibited trends.

Once the set of contributing factors and impacts have been identified for a particular demographic group, it is possible to apply those impacts to individual policies similar to that group and impute their effect, calculating a projected future value for payment streams associated with such policies and a portfolio as a whole. An example of this process would be the evaluation of a portfolio of insurance policies written by insurance carrier A in state B, where carrier A has previously demonstrated a −5% annualized impact on payment trend and state B has previously exhibited a +5% annualized impact on payment trend versus the population as a whole. By combining the separate impacts of −5% and +5% to a sum of 0% total impact, it is possible to conclude that the payment trend of the portfolio in question will be reasonably similar to that of the population as a whole.

In another aspect of the present invention, experiential data is used to manage a portfolio of insurance policies. In step 20, in addition to correlating demographic data with financial data the invention additionally may determine that certain demographic or financial characteristics are predictive of insurance policies that are likely to have undesired financial results unless preventative measures are taken (“Problematic Policies”). In step 22, in addition to identifying relevant demographic data in a portfolio the invention additionally may select policies that correlate to those Problematic Policies and thus initiate appropriate measures to try to prevent the undesired financial results. Thus, in step 24 in addition to providing a projected value, the invention may also provide one or more risk factor values for various types of potential negative results. An organization managing the insurance policies may use such risk factor values in determining if and where to expend resources on the portfolio. A risk factor value may be identified with an index value for the risk factor so that any policies having a value greater than a predetermined index value would be identified for preventative measures. Risk factors that may be used for creating index values include, but are not limited to, death, morbidity, or other predictors of voluntary lapsing of a policy.

Similar to the identification of causal factors for payment trends, mathematical trend analysis is applied to payment timing to determine a general risk factor for lapsation. For example, if it is known from prior experience that the general range of payment with respect to a premium due date is N days prior for policy type O and mode P, then variations of payment mode and proximity to due date generally leads to different risk factors for lapsation. Identification and application of such risk factors to individual policies permits interventionary actions to be taken with respect to such policies to improve subsequent payment performance.

In a further aspect of the present invention, updated experiential data may be provided to the experiential database that might change the valuation of step 22. In combination with the segregation of demographic data, the invention may determine over the course of time that a portion of a portfolio now has a lower projected valuation than first calculated in step 24. With this additional information, an organization managing that portfolio may determine that the lower valued portion of the portfolio should be terminated, although the remainder of the portfolio should be maintained. In this way, discrete portions of a portfolio may be separate valued and managed appropriately.

An example of this aspect is a portfolio of X policies of which Y policies are in the payment grace period and Z policies are not. If it is known from prior experience that policies in the payment grace period generally exhibit a −5% annualized impact on payment trend, then managing such policies more closely (by contact with the agent, the policyholder, etc.) generally improves the otherwise negative impact.

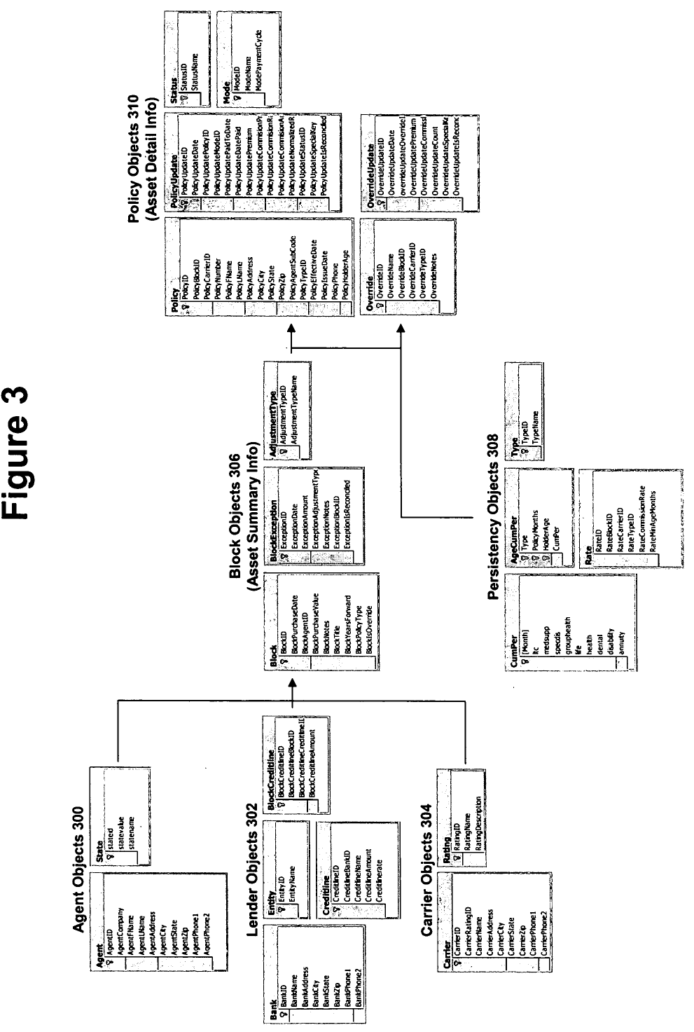

A data diagram representing one implementation of the present invention is provided in FIG. 3. Information about the organizations involved in the various policies of a portfolio are depicted on the left side of the data diagram with the Agent Objects 300, Lender Objects 302, and Carrier Objects 304. These organization related objects relate to Block Objects 306 which includes asset summary information. Persistency Objects 308 includes data about the portfolio, which with Block Objects 306 directly relate the Policy Objects 310 which includes asset detail information. The individual data components shown in FIG. 3 provide a methodology for organizing information relevant to the calculations and procedures described above.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A computer for evaluating a portfolio of insurance policies, said computer comprising:
means for determining relevant data from a database of experiential data relating to insurance policies;
means for analyzing characteristics of a portfolio of insurance policies and identifying correspondence to the relevant data from the determining means; and
means for calculating a valuation for the portfolio based on the experiential data from the determining means and the characteristics analyzed by said analyzing means.

2. The computer of claim 1 wherein said determining means includes a database of experiential data relating to insurance policies with financial data and associated demographic data.

3. The computer of claim 1 further comprising means for indexing policies of the portfolio based on predetermined risk factors.

4. The computer of claim 1 further comprising means for updating the experiential data for said determining means and activating said calculating means when new experiential data is obtained.

5. In computer, a method of determining a value for a portfolio of insurance policies, said method comprising the steps of:
determining relevant data from a database of experiential data relating to insurance policies;
analyzing characteristics of a portfolio of insurance policies and identifying correspondence to the relevant data; and
calculating a valuation for the portfolio based on the experiential data and the analyzed characteristics.

6. The method of claim 5 wherein said step of determining relevant data includes identifying demographic data and associated financial data.

7. The method of claim 5 further comprising the step of calculating an index value for policies in the portfolio based on a predetermined risk factor.

8. The method of claim 5 further comprising the step of updating the experiential data and calculating a valuation of a portion of a portfolio when new experiential data is obtained.

9. A machine-readable program storage device for storing encoded instructions for a method of determining a value for a portfolio of insurance policies, said method comprising the steps of:
determining relevant data from a database of experiential data relating to insurance policies;
analyzing characteristics of a portfolio of insurance policies and identifying correspondence to the relevant data; and
calculating a valuation for the portfolio based on the experiential data and the analyzed characteristics.

10. The machine-readable program storage device of claim 9 wherein said step of determining relevant data includes identifying demographic data and associated financial data.

11. The machine-readable program storage device of claim 9 further comprising the step of calculating an index value for policies in the portfolio based on a predetermined risk factor.

12. The machine-readable program storage device of claim 9 further comprising the step of updating the experiential data and calculating a valuation of a portion of a portfolio when new experiential data is obtained.
